(19) United States
(12) Patent Application Publication
(10) Pub. No.: US 2012/0213426 A1
(43) Pub. Date: Aug. 23, 2012

(54) Method for Implementing a High-Level Image Representation for Image Analysis

(75) Inventors: Li Fei-Fei, Stanford, CA (US); Li-Jia Li, Stanford, CA (US); Hao Su, Stanford, CA (US)

(73) Assignee: The Board of Trustees of the Leland Stanford Junior University, Palo Alto, CA (US)

(21) Appl. No.: 12/960,467

(22) Filed: Feb. 22, 2011

(51) Int. Cl. G06K 9/62; G06K 9/46

(52) U.S. Cl. 382/159; 382/190

(57) ABSTRACT

Robust low-level image features have been proven to be effective representations for a variety of visual recognition tasks such as object recognition and scene classification; but pixels, or even local image patches, carry little semantic meanings. For high-level visual tasks, such low-level image representations are potentially not enough. The present invention provides a high-level image representation where an image is represented as a scale-invariant response map of a large number of pre-trained generic object detectors, blind to the testing dataset or visual task. Leveraging on this representation, superior performances on high-level visual recognition tasks are achieved with relatively classifiers such as logistic regression and linear SVM classifiers.

### FIELD OF THE INVENTION

The present invention generally relates to the field of image processing. More particularly, the present invention relates to image processing using high-level image information.

### BACKGROUND OF THE INVENTION

Understanding the meanings and contents of images remains one of the most challenging problems in machine intelligence and statistical learning. Contrast to inference tasks in other domains, such as NLP, where the basic feature space in which the data lie usually bears explicit human perceivable meaning, e.g., each dimension of a document embedding space could correspond to a word, or a topic, common representations of visual data primarily build on raw physical metrics of the pixels such as color and intensity, or their mathematical transformations such as various filters, or simple image statistics such as shape, and edges orientations among other things. Depending on the specific visual inference task, such as classification, a predictive method is deployed to pool together and model the statistics of the image features, and make use of them to build some hypothesis for the predictor.

Robust low-level image features have been effective representations for a variety of visual recognition tasks such as object recognition and scene classification, but pixels, or even local image patches, carry little semantic meanings. For high-level visual tasks, such low-level image representations may not be satisfactory.

Much work has been performed in the area of image classification or feature identification in images. For example, toward identifying features in an image, significant work has been performed on low-level features of an image. To the extent digital images are a collection of pixels, much work has been performed on how a collection of many pixels provides visual information. It is, therefore, a goal of such methods to take low-level information and generate higher-level information about the image. Indeed, some of the results generated by low-level analysis can be difficult for a human-perceived analysis of an image, for example, a radiographic image containing very small speculations that may be indicative of a cancerous tumor.

But it can also be desirable to identify higher-level information about an image that is visually obtained from a lay person. For example, a viewer can readily identify everyday objects in a photograph that may contain, for example, people, houses, animals, and other objects. Moreover, a viewer can readily identify context in an image, for example, a sporting event, an activity, a task, etc. It can, therefore, be desirable to identify high-level features in an image that could be appreciated by viewers so that they may be retrieved upon a query, for example.

### SUMMARY OF THE INVENTION

Recognizing and analyzing certain high-level information in images can be difficult for prior art low-level algorithms. But the present invention takes a different approach. Rather than relying strictly on low-level information, the present invention makes use of high-level information from a collection of images. Among other things, the present invention uses many object detectors at different image location and scale to represent features in images.

The present invention generally relates to understanding the meaning and content of images. More particularly, the present invention relates to a method for the representation of images based on known objects. The present invention uses a collection of object sensing filters to classify scenes in an image or to provide information on semantic features of the image. The present invention provides useful results in performing high-level visual recognition tasks in cluttered scenes. Among other things, the present invention is able to provide this information by making use of known datasets of images.

An embodiment of the present invention generates an Object Bank that is an image representation constructed from the response of multiple object detectors. For example, an object detector could detect the presence of “blobby” objects such as tables, cars, humans, etc. Alternatively, an object detector can be a texture classifier optimized for detecting sky, road, sand, etc. In this way, the Object Bank contains generalized high-level information, e.g., semantic information, about objects in images.

In an embodiment, a collection of images from a complex dataset are used to train the classification algorithm of the present invention. Thereafter, an image having unknown content is input. The algorithm of the present invention then provides classification information about the scene in the image. For example, the algorithm of the present invention can be trained with images of sporting activities so as to identify the types of activities, e.g., skiing, snowboarding, rock climbing, etc., shown in an image.

Results from the present invention, indicate that, in certain recognition tasks, it performs better than certain low-level feature extraction algorithms. In particular, the present invention provides better results in classification tasks that may have similar low-level information but different high-level information. For example, certain low-level prior art algorithms may struggle to distinguish a bedroom image from a living room image because much of the low-level information, e.g., texture, is similar in both types of images. The present invention, however, can make use of certain high-level information about the objects in the image, e.g., bed or table, and their arrangement to distinguish between the two scenes.

In an embodiment, the present invention makes use of a high-level image representation where an image is represented as a scale-invariant response map of a large number of pre-trained object detectors, blind to the testing dataset or visual task. Using the Object Bank representation, improved performance on high-level visual recognition tasks can be achieved with off-the-shelf classifiers such as logistic regression and linear SVM.

### BRIEF DESCRIPTION OF THE DRAWINGS

The following drawings will be used to more fully describe embodiments of the present invention.

FIG. 1 is a computer system on which the present invention may be implemented.

FIG. 2 is a flow chart of a conventional low-level image analysis.

FIG. 3 is a flow chart of an image processing algorithm according to an embodiment of the present invention.

FIG. 4 is a flow chart of an image processing algorithm according to an embodiment of the present invention.

FIG. 5 is a diagram illustrating certain steps of an image processing algorithm according to an embodiment of the present invention.

FIG. 6 is a diagram illustrating a hierarchy of image names according to an embodiment of the present invention.

FIG. 7 is a list of image names as used in an embodiment of the present invention.

FIG. 8 is a diagram of responses comparing conventional methods to an embodiment of the present invention.

FIG. 9 is a chart illustrating how a distribution of objects generally follows Zipf's Law.

FIG. 10 is a detection performance graph of the top 15 object detectors as used in an embodiment of the invention.

FIGS. 11a-d are graphs that summarize the results on scene classification based on an embodiment of the invention and a set of known low-level feature representations: GIST, Bag of Words (BOW) and Spatial Pyramid Matching (SPM) on four scene datasets

### DETAILED DESCRIPTION OF THE INVENTION

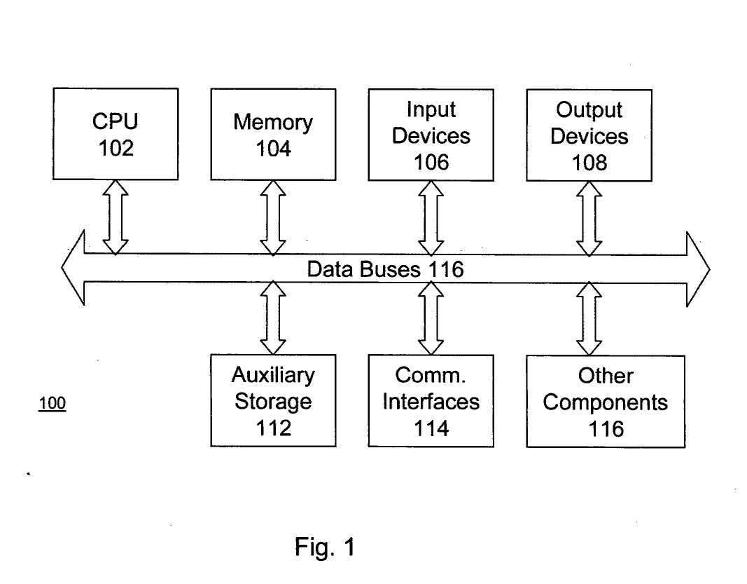

Among other things, the present disclosure relates to methods, techniques, and algorithms that are intended to be implemented in a digital computer system 100 such as generally shown in FIG. 1. Such a digital computer is well-known in the art and may include the following.

Computer system 100 may include at least one central processing unit 102 but may include many processors or processing cores. Computer system 100 may further include memory 104 in different forms such as RAM, ROM, hard disk, optical drives, and removable drives that may further include drive controllers and other hardware. Auxiliary storage 112 may also be include that can be similar to memory 104 but may be more remotely incorporated such as in a distributed computer system with distributed memory capabilities.

Computer system 100 may further include at least one output device 108 such as a display unit, video hardware, or other peripherals (e.g., printer). At least one input device 106 may also be included in computer system 100 that may include a pointing device (e.g., mouse), a text input device (e.g., keyboard), or touch screen.

Communications interfaces 114 also form an important aspect of computer system 100 especially where computer system 100 is deployed as a distributed computer system. Computer interfaces 114 may include LAN network adapters, WAN network adapters, wireless interfaces, Bluetooth interfaces, modems and other networking interfaces as currently available and as may be developed in the future.

Computer system 100 may further include other components 116 that may be generally available components as well as specially developed components for implementation of the present invention. Importantly, computer system 100 incorporates various data buses 116 that are intended to allow for communication of the various components of computer system 100. Data buses 116 include, for example, input/output buses and bus controllers.

Indeed, the present invention is not limited to computer system 100 as known at the time of the invention. Instead, the present invention is intended to be deployed in future computer systems with more advanced technology that can make use of all aspects of the present invention. It is expected that computer technology will continue to advance but one of ordinary skill in the art will be able to take the present disclosure and implement the described teachings on the more advanced computers as they become available. Moreover, the present invention may be implemented on one or more distributed computers. Still further, the present invention may be implemented in various types of software languages including C, C++, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

The present disclosure provides a detailed explanation of the present invention with detailed formulas and explanations that allow one of ordinary skill in the art to implement the present invention into a computer learning method. For example, the present disclosure provides detailed indexing schemes that readily lend themselves to multi-dimensional arrays for storing and manipulating data in a computerized implementation. Certain of these and other details are not included in the present disclosure so as not to detract from the teachings presented herein but it is understood that one of ordinary skill in the at would be familiar with such details.

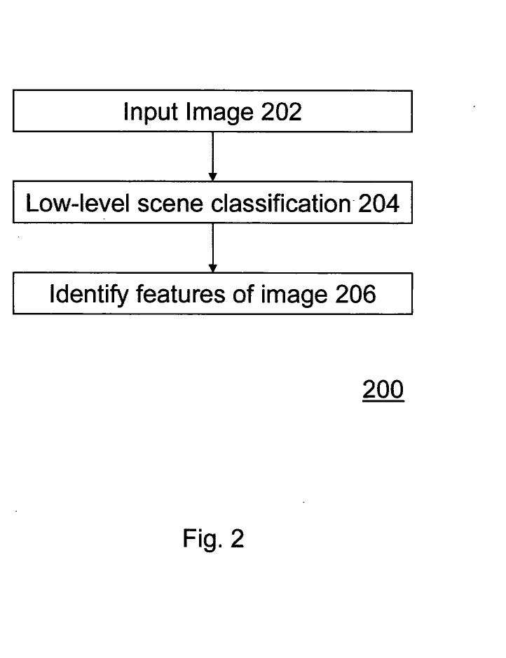

Turning now more particularly to image processing, conventional image and scene classification has been done at low levels such as generally shown in FIG. 2. As shown, image processing algorithm 200 receives inputted images 202 and passes them through a low-level scene classification algorithm 204 that analyzes low-level features (e.g., at the pixel level) of the inputted image so as to attempt to identify features of the image 206. Such low-level image classification algorithms are typically computationally intensive and exhibit known limitations.

While more sophisticated low-level feature engineering and recognition model design remain important sources of future developments, the use of semantically more meaningful feature space, such as one that is directly based on the content (e.g., objects) of the images, as words for textual documents, can offer another venue to empower a computational visual recognizer to handle arbitrary natural images, especially in our current era where visual knowledge of millions of common objects are readily available from various easy sources on the Internet.

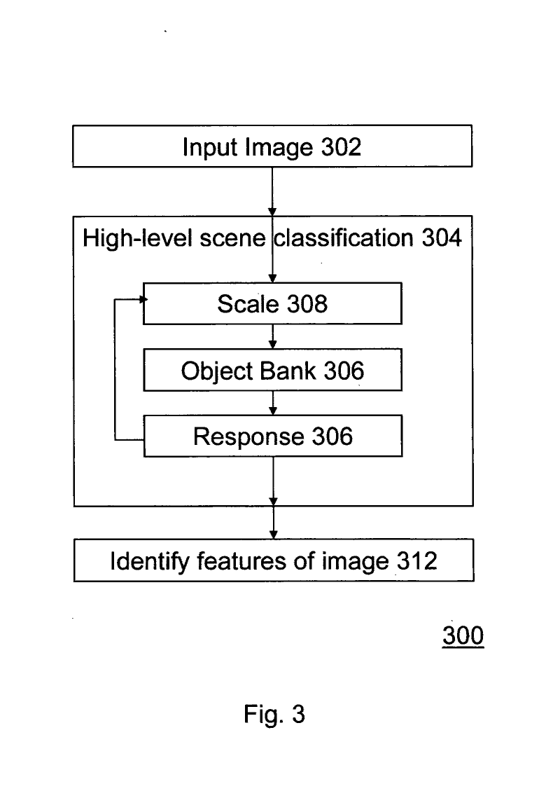

Rather than making use of only low-level features, the present invention makes use of high-level features (e.g., objects in an image) to better classify images. Shown in FIG. 3 is a representation of a high-level image processing algorithm 300 according to an embodiment of the invention. As shown, high-level image processing algorithm 300 receives inputted images 302 and passes them through a high-level image classification algorithm 304 for analysis. High-level image processing algorithm 300 includes Object Bank 306 that is a high-level image representation for predetermined objects constructed from the responses of many object detectors. In an embodiment, the inputted images are scaled 308 at different levels and Object Bank responses 310 are recorded. Based on the collection of responses, features including high-level image content is identified 312.

The Object Bank (also called “OB”) of the present invention makes use of a representation of natural images based on objects, or more rigorously, a collection of object sensing filters built on a generic collection of labeled objects.

The present invention provides an image representation based on objects that is useful in high-level visual recognition tasks for scenes cluttered with objects. The present invention provides complementary information to that of the low-level features.

While the OB representation of the present invention offers a rich, high-level description of images, a key technical challenge due to this representation is the “curse of dimensionality,” which is severe because of the size (i.e., number of objects) of the object bank and the dimensionality of the response vector for each object. Typically, for a modestly sized picture, even hundreds of object detectors can result in a representation of tens of thousands of dimensions. Therefore, to achieve a robust predictor on a practical dataset with typically only dozens or a few hundreds of instances per class, structural risk minimization via appropriate regularization of the predictive model is important. In an embodiment, the present invention can be implemented with or without compression.

### The Object Bank Representation of Images

The present invention provides an Object Bank that is an image representation constructed from the responses of many object detectors, which can be viewed as the response of a “generalized object convolution.” In an embodiment, two detectors are used for this operation. More particularly, latent SVM object detector and a texture classifier are used. One of ordinary skill will, however, recognize that other detectors can be used without deviating from the teachings of the present invention. The latent SVM object detectors are useful for detecting blobby objects such as tables, cars, and humans among other things. The texture classifier is useful for more texture- and material-based objects such as sky, road, and sand among other things.

As used in the present disclosure, “object” is used in its most general form to include, for example, things such as cars and dogs but also other things such as sky and water. Also, the image representation of the present invention is generally agnostic to any specific type of object detector.

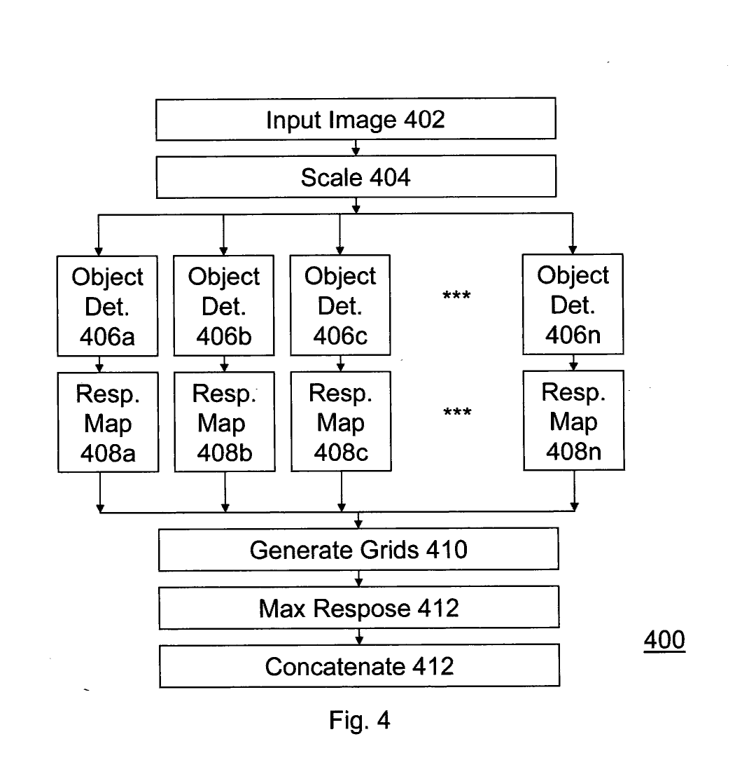

FIG. 4 shows algorithm 400 for obtaining Object Bank representations according to the present invention. As shown, a number of object detectors 406 are run across an image 402 at different scales 404. For each scale 404 and each detector 406, a response map 408 of the image is obtained to generate a three-level spatial pyramid representation of the resulting object filter map. The result is the generation of No.Objects×No.Scales×(1²+2²+4²) grids 410. The maximum response 412 for each object in each grid is then computed, resulting in a No.Objects length feature vector for each grid. A concatenation of features in all grids leads to an OB descriptor 414 for the image.

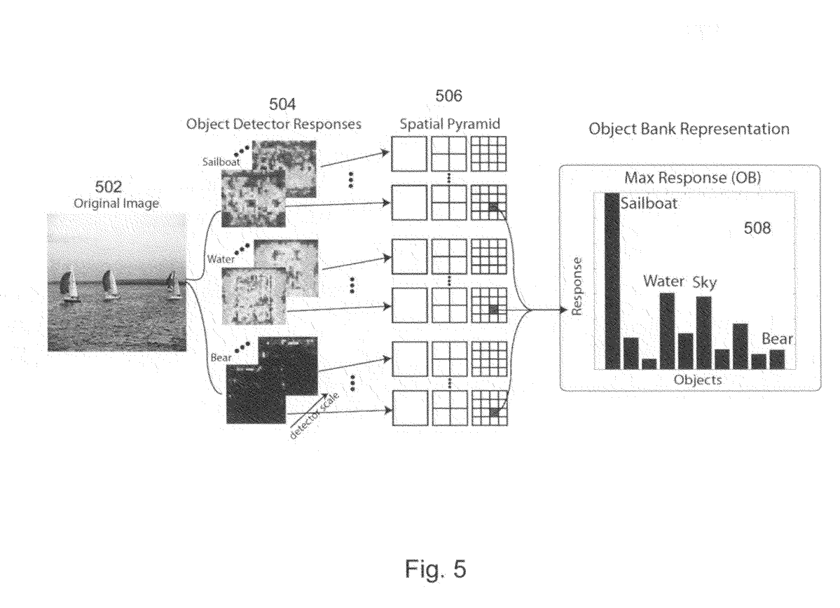

FIG. 5 illustrates the application of algorithm 400 according to the present invention. A number of object detectors 504 are run across an image 502 at different scales. As shown in FIG. 5, image 502 is of a sailing scene that predominantly includes sailboats, water, and sky. For each scale and each detector, an initial response map 506 of the image is obtained. For example, a response map can be generated in response to the objects sailboat, water, and bear. A maximum response 508 for each object in each grid is then computed. The high-level image processing algorithm of the present invention, therefore, generates high levels of response to the objects sailboat and water, for example, but not for bear as shown in max response graph 508.

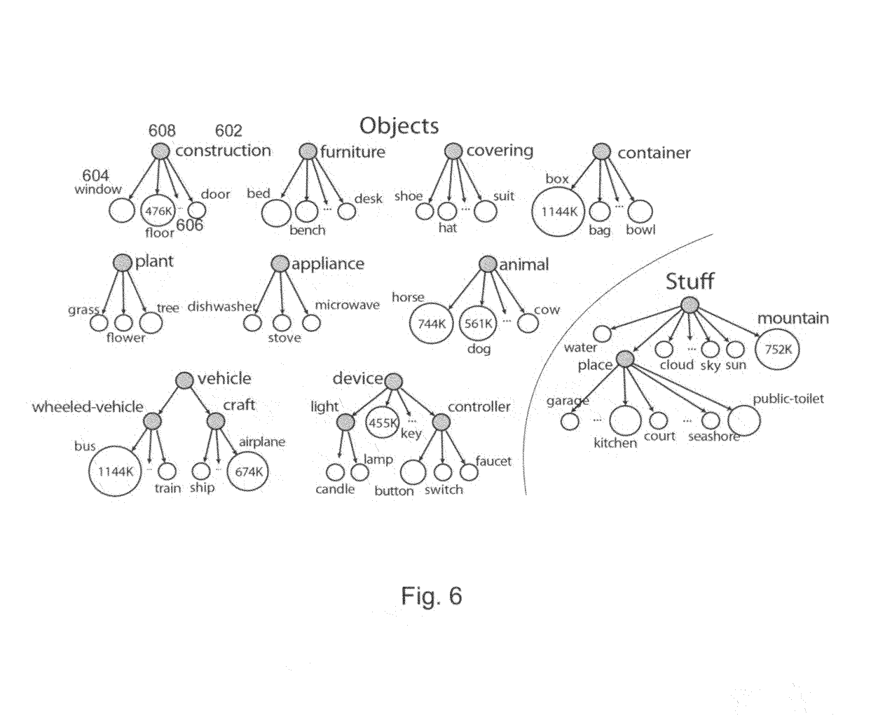

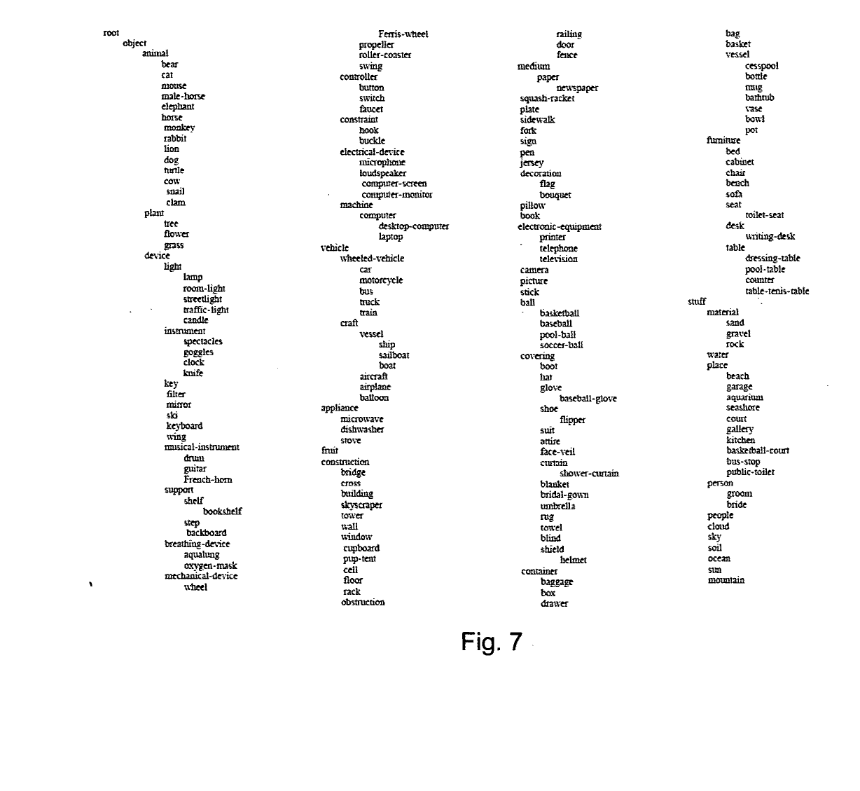

Certain object names as may be used in the Object Bank of the present invention are shown in FIG. 6. As shown, the object names (for example, object names 602 and 604) are generally grouped based on a hierarchy as maintained by WordNet. As a visual representation, the size of each unshaded node (for example, node 606) generally corresponds to the number of images returned by a search. Note also that due to space limitations, only objects appearing in the top two levels in the hierarchy are shown. The full list of object names as used in an embodiment of the invention is shown in FIG. 7.

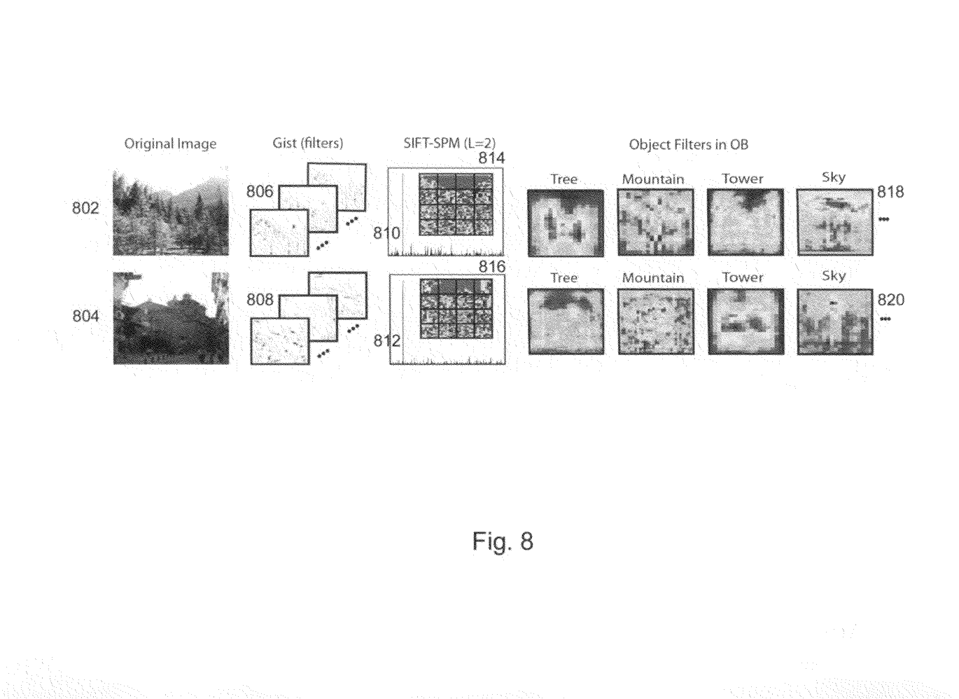

The image processing algorithm of the present invention, therefore, introduces a shift in the manner of processing images. Whereas conventional image processing operates at low levels (e.g., pixel level), the present invention operates at a higher level (e.g., object level). Shown in FIG. 8 is a comparison of response of conventional image processing algorithms to the present invention. As shown, images 802 and 804 were processed with conventional GIST and SIFT-SPM algorithms as well as the Object Bank algorithm of the present invention. As shown, image 802 is generally of a mountain scene and image 804 is generally of a city street scene. For the GIST algorithm, filter responses 806 and 808 are shown. Filter responses 806 and 808 do not demonstrate sufficient discriminative power as demonstrated by the generally similar responses of 806 and 808. For the SPM algorithm, histograms 810 and 812 are shown for SIFT patches 814 and 816, respectively. Here again, histograms 810 and 812 and SIFT patches 814 and 816 do not demonstrate sufficient discriminative power as demonstrated by the generally similar responses.

Finally, a selected number of Object Bank responses 818 are shown with varying levels of response for the different images 802 and 804. As illustrated in FIG. 8, images 802 and 804 show very different Object Bank responses 818 to objects such as tree, street, water, sky, etc. This demonstrates the discriminative power of the high-level image processing algorithm of the present invention.

Given the availability of large-scale image datasets such as LabelMe and ImageNet, trained object detectors can be obtained for a large number of visual concepts. In fact, as databases grow and computational power improves thousands if not millions of object detectors can be developed for use in accordance with the present invention.

### Implementation Details of Object Bank

In an embodiment, 200 object detectors are used at 12 detection scales and 3 spatial pyramid levels (L=0, 1, 2). This is a general representation that can be applicable to many images and tasks. The same set of object detectors can be used for many scenes and datasets. In other embodiments, the number of object detectors is in the range from 100 to 300. In still other embodiments, images are scaled in the range from 5 to 20 times. In still other embodiments, up to 10 spatial pyramid levels are used.

Many or substantially all types of objects can be used in the Object Bank of the present invention. Indeed, as the detectors continue to become more robust, especially with the emergence of large-scale datasets such as LabelMe and ImageNet, use of substantially all types of objects becomes more feasible.

But computational intensity and computation time, among other things, can limit the types of objects to use. For example, the use of all the objects in the LabelMe dataset may be computationally intensive and presently infeasible. As computational power and computational techniques improve, however, larger datasets may be used in accordance with the present invention.

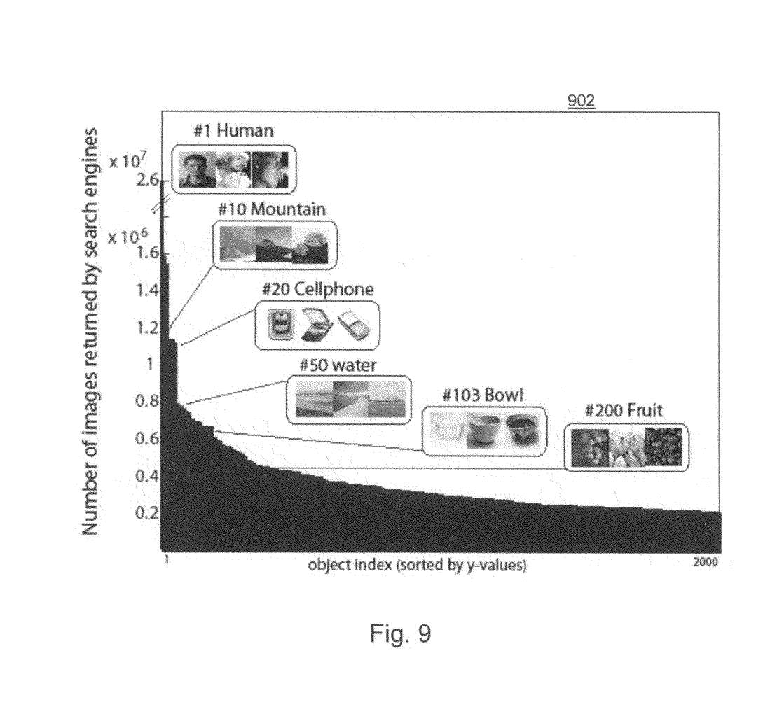

As shown in graph 902, FIG. 9, the distribution of objects follows Zipf's Law, which implies that a small proportion of object classes account for the majority of object instances. Indeed, some have postulated that using 3000-4000 concepts can be used to satisfactorily annotate most video data, for example.

In an embodiment, a few hundred of the most useful (or popular) objects in images were used. An practical consideration is ensuring the availability of enough training images for each object detector. Such embodiment, therefore, focuses attention on obtaining the objects from popular image datasets such as ESP, LabelMe, ImageNet and the Flickr online photo sharing community, for example.

After ranking the objects according to their frequencies in each of these datasets, an embodiment of the present invention takes the intersection set of the most frequent 1000 objects, resulting in 200 objects, where the identities and semantic relations of some of them are as shown with reference to FIGS. 6 and 7.

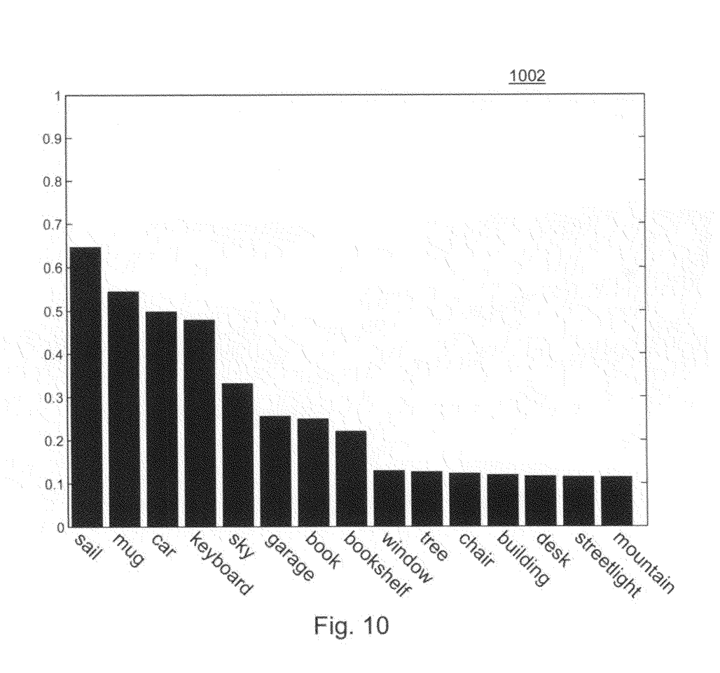

To train each of the 200 object detectors, 100-200 images and their object bounding box information were used from the LabelMe (86 objects) and ImageNet datasets (177 objects). A subset of the LabelMe scene dataset was used to evaluate the object detector performance. Final object detectors are selected based on their performance on the validation set from LabelMe. Shown in FIG. 10 is the detection performance graph 1002 of the top 15 object detectors using average precision to evaluate the detection performance on a subset of 3000 LabelMe images.

### Experiments and Results

The OB representation was evaluated and shown to have improved results on four scene datasets, ranging from generic natural scene images (15-Scene, LabelMe 9-class scene dataset), to cluttered indoor images (MIT Indoor Scene), and to complex event and activity images (UIUC-Sports). From 100 popular scene names, nine classes were obtained from the LabelMe dataset in which there are more than 100 images, e.g., beach, mountain, bathroom, church, garage, office, sail, street, and forest. The maximum number of images in those classes is 1000.

Scene classification performance was evaluated by average multi-way classification accuracy over all scene classes in each dataset. Below is a list of the various experiment settings for each dataset:
15-Scene: This is a dataset of 15 natural scene classes with 100 images in each class for training and rest for testing.
LabelMe: This is a dataset of 9 classes with 50 images randomly drawn images from each scene class that are used for training and 50 for testing.
MIT Indoor: This is a dataset of 15620 images over 67 indoor scenes where 80 images from each class are used for training and 20 for testing.
UIUC-Sports: This is a dataset of 8 complex event classes where 70 randomly drawn images from each class are used for training and 60 for testing following.

### Experiment Setup

OB in scene classification tasks were compared with different types of conventional image features such as SIFT-BoW, GIST and SPM.

A conventional SVM classifier and a customized implementation of the logistic regression (LR) classifier were used on all feature representations being compared. The behaviors of different structural risk minimization schemes were investigated over LR on the OB representation. The following logistic regressions were analyzed: lₗ regularized LR (LR1), l₁/l₂ regularized LR (LRG) and lₗ/l₂+l₁ regularized LR (LRG1).

The implementation details are as follows:
For LR1 and LRG, the Projected Quasi-Newton (PQN) algorithm proposed by Kevin Murphy et. al was used. The PQN algorithm uses a two-layer scheme to solve the dual form: the outer layer uses L-BFGS updates to construct a sequence of constrained, quadratic approximations; and the inner level uses a spectral projected-gradient method to approximately minimize this subproblem.
For LGR1, the coordinate descent algorithm described above was implemented. To speed up the convergence, the learned parameter from LR and LRG was used as the initialization point.

### Scene Classification

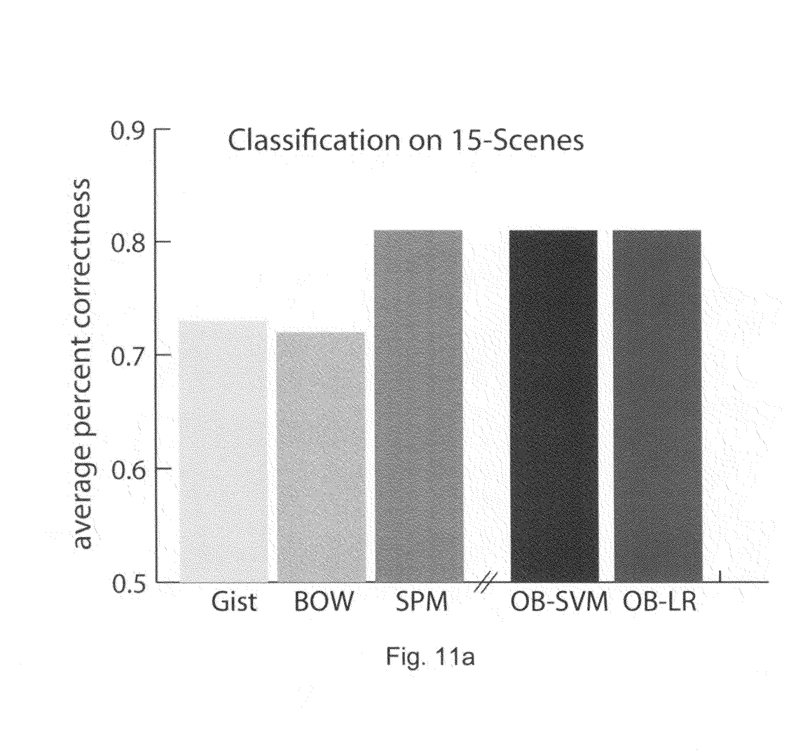

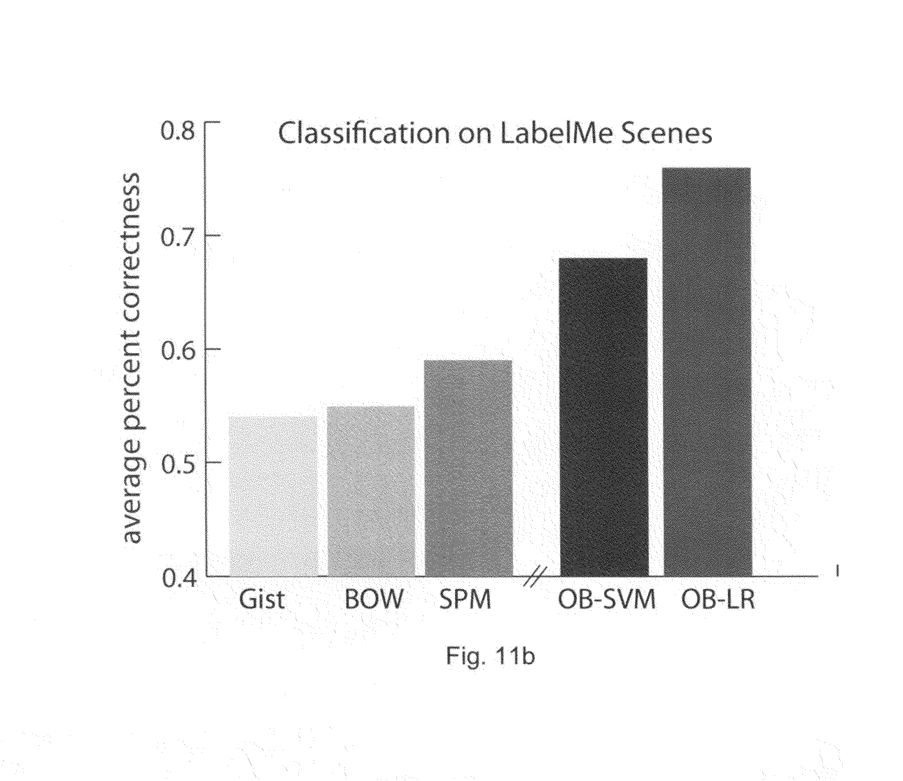

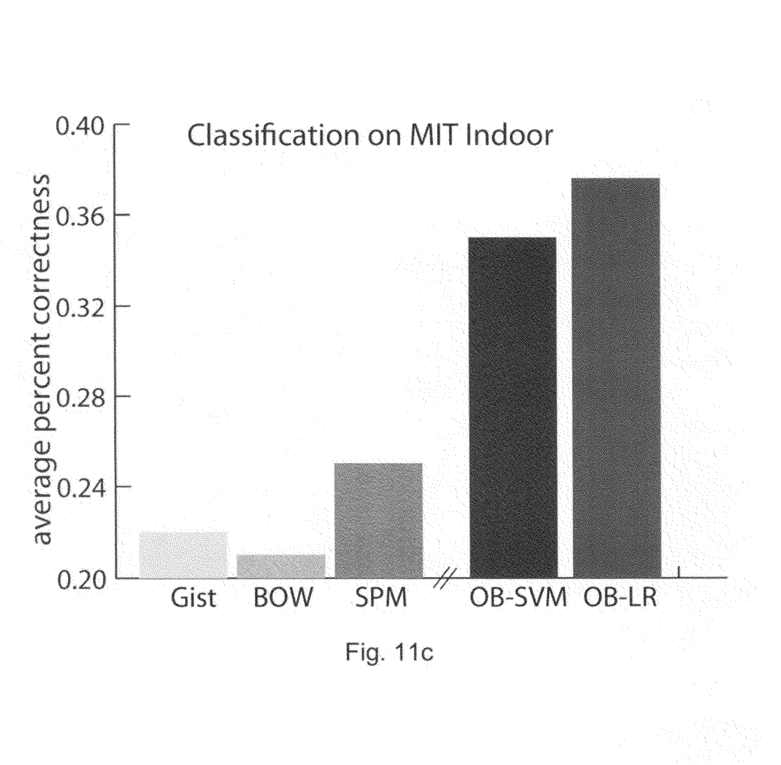

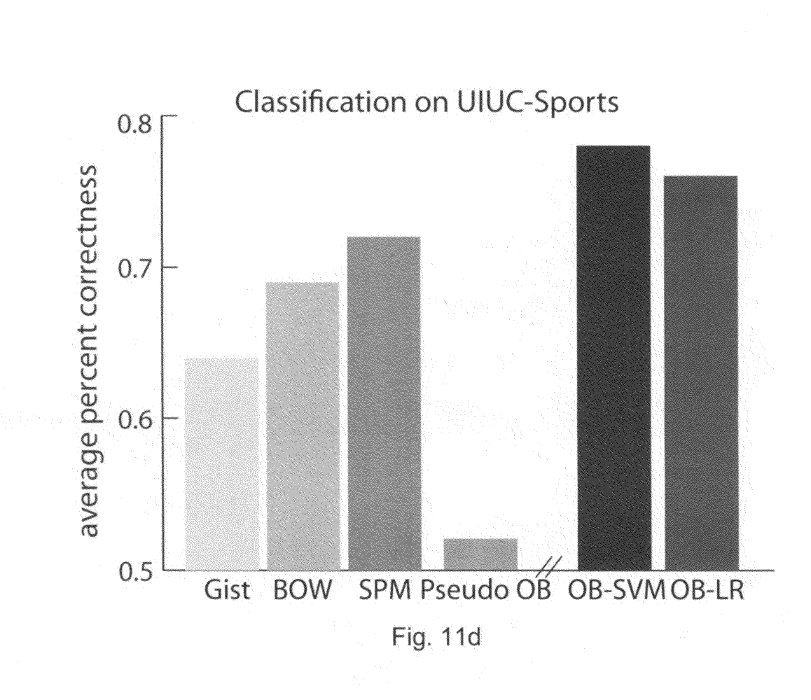

FIG. 11a-d summarize the results on scene classification based on the Object Bank of the present invention and a set of known low-level feature representations: GIST, Bag of Words (BOW) and Spatial Pyramid Matching (SPM) on four challenging scene datasets. Comparison of classification performance of different features (GIST vs. BOW vs. SPM vs. OB) and classifiers (SVM vs. LR) on 15 scene (FIG. 11a), LabelMe (FIG. 11b), MIT-Indoor (FIG. 11c), and UIUC-Sports (FIG. 11d) datasets. In the LabelMe dataset (FIG. 11b), the “ideal” classification accuracy is 90%, where the human ground-truth object identities were used to predict the labels of the scene classes.

Also shown in FIG. 11d is the performance of a “pseudo” object bank representation extracted from the same number of “pseudo” object detectors. The values of the parameters in these “pseudo” detectors are generated without altering the original detector structures. In the case of linear classifier, the weights of the classifier are randomly generated from a uniform distribution instead of learned. “Pseudo” OB is then extracted with exactly the same setting as OB.

Improved performance was shown on three out of four datasets (FIGS. 11b, c, and d), and equivalent performance was shown with the 15-Scene dataset (FIG. 11a). The substantial performance gain on the UIUC-Sports (FIG. 11d) and the MIT-Indoor (FIG. 11c) scene datasets illustrates the importance of using a semantically meaningful representation for complex scenes cluttered with objects. For example, the difference between a living room and a bedroom is less so in the overall texture (easily captured by BoW or GIST) but more so in the different objects and their arrangements. This result underscores the effectiveness of the OB, highlighting the fact that in high-level visual tasks such as complex scene recognition, a higher level image representation can be very useful.

The classification performance of using the detected object location and its detection score of each object detector as the image representation was also evaluated. The classification performance of this representation is 62.0%, 48.3%, 25.1% and 54% on the 15 scene, LabelMe, UIUC-Sports and MIT-Indoor datasets respectively.

The spatial structure and semantic meaning encoded in OB of the present invention by using a “pseudo” OB (FIG. 11d) without semantic meaning was further decomposed. The significant improvement of OB in classification performance over the “pseudo object bank” is largely attributed to the effectiveness of using object detectors trained from image.

The reported state of the art performances were compared to the OB algorithm (using a standard LR classifier) as shown in Table 1 for each of the existing scene datasets (UIUC-Sports, 15-Scene and MIT-Indoor). Other algorithms use more complex model and supervised information whereas the results from the present invention are obtained by applying a relatively simple logistic regression.

TABLE 1
Control Experiment: Object Recognition

| | | UIUC- | MIT- |
|---|---|---|---|
| | 15-Scene | Sports | Indoor |
| state-of- | 72.2% [20] | 66.0% [34] | 26% [29] |
| the-art | 81.1% [20] | 73.4% [23] | |
| OB | 80.9% | 76.3% | 37.6% |

OB is constructed from the responses of many objects, which encodes the semantic and spatial information of objects within images. It can be naturally applied to object recognition task.

The object recognition performance on the Caltech 256 dataset is compared to a high-level image representation obtained as the output of a large number of weakly trained object classifiers on the image. By encoding the spatial locations of the objects within an image, OB (39%) significantly outperforms the weakly trained object classifiers (36%) on the 256-way classification task where performance is measured as the average of the diagonal values of a 256×256 confusion matrix.

It should be appreciated by those skilled in the art that the specific embodiments disclosed above may be readily utilized as a basis for modifying or designing other image processing systems and methods. It should also be appreciated by those skilled in the art that such modifications do not depart from the scope of the invention as set forth in the appended claims.

What is claimed is:

1. A method for image processing comprising the steps of:
inputting an image having unknown object content;
generating at least one scale of the image;
generating first responses of the at least one scale of the image to predetermined filters, wherein the predetermined filters are trained to generate responses to at least one predetermined object.
generating second responses indicative of the presence of an identified object in the image, wherein the identified object is chosen from the at least one predetermined object.

2. The method of claim 1, wherein first responses are generated at multiple scales of the image.

3. The method of claim 1, further comprising generating a spatial representation responsive to the first responses.

4. The method of claim 3, further comprising generating a set of first grids responsive to the spatial representation.

5. The method of claim 4, further comprising collecting object information from the first set of grids.

6. The method of claim 1, wherein the at least one predetermined object is a number of predetermined objects between 100 and 300.

7. The method of claim 1, wherein the at least one scale of the image is a number of scales of the image between 5 and 20.

8. The method of claim 3, wherein the spatial representation contains information of at least three spatial levels.

9. The method of claim 3, wherein the spatial representation is a spatial pyramid.

10. The method of claim 1, wherein the predetermined filters are linear classifiers.

11. A method for image processing comprising the steps of:
receiving multiple training images;
receiving object content information about the multiple training images;
training at least one adaptive filter to generate a response indicative of the presence of a predetermined object, wherein the training of the adaptive filter is responsive to the multiple training images and the object content information.

12. The method of claim 11, wherein the training of the adaptive filter is responsive to multiple scales of the multiple training images.

13. The method of claim 11, wherein the multiple training images are a number of images of approximately 100 to 200.

14. The method of claim 11, wherein the object content information includes information about the presence of at least one predetermined object.

15. The method of claim 11, wherein the at least one adaptive filter is a number of adaptive filters of approximately 100 to 300.

16. The method of claim 11, wherein the at least one adaptive filter is a linear classifier.

17. The method of claim 11, wherein the at least one adaptive filter comprises a logistic regression classifier.

18. The method of claim 11, wherein the at least one adaptive filter comprises an SVM classifier.

19. The method of claim 11, wherein the object content information includes information about images of humans.

20. The method of claim 11, wherein object content information includes information about human images.

21. A method for classifying an image comprising the steps of:
receiving multiple training images;
receiving object-level feature information about the multiple training images;
training at least one object detector using the multiple training images and the high-level feature information;
generating first responses of the object detector to a first image;
generating at least one classification for features of the first image responsive to the first responses.

22. The method of claim 21, wherein first responses are generated at multiple scales of the first image.

23. The method of claim 21, further comprising generating a spatial representation responsive to the first responses.

24. The method of claim 23, further comprising generating a set of first grids responsive to the spatial representation.

25. The method of claim 24, further comprising collecting object information from the first set of grids.

26. The method of claim 21, wherein the at least one object detector is a number of predetermined objects between 100 and 300.

27. The method of claim 22, wherein the multiple scales of the first image is a number of scales of the image between 5 and 20.

28. The method of claim 23, wherein the spatial representation contains information of at least three spatial levels.

29. The method of claim 23, wherein the spatial representation is a spatial pyramid.

30. The method of claim 1, wherein the predetermined filters are linear classifiers.
